(19) United States
(12) Patent Application Publication
(10) Pub. No.: US 2015/0363875 A1
(43) Pub. Date: Dec. 17, 2015

(54) System and Method for Filtering and Analyzing Transaction Information

(71) Applicant: William Wright Guerry, Atlanta, GA (US)

(72) Inventor: William Wright Guerry, Atlanta, GA (US)

(21) Appl. No.: 14/737,673

(22) Filed: Jun. 12, 2015

Related U.S. Application Data
(60) Provisional application No. 62/011,342, filed on Jun. 12, 2014.

(51) Int. Cl. G06Q 40/02

(52) U.S. Cl. CPC G06Q 40/025

(57) ABSTRACT

A system uses both structured and unstructured data to identify an existing product for a customer held at a competing institution. The data is received from a computer system of clients currently using various products. Data is also received from external systems and may be in the form of documents or other text-based sources of information. The structured and unstructured data is filtered and analyzed to identify transactions with common characteristics. The system identifies the customer, product, and amount for each transaction. The data is analyzed to identify common characteristics such as terms or patterns. The transactions are clustered and a product associated with the transactions is identified.

### CROSS REFERENCE TO RELATED APPLICATION

This application claims priority to Provisional U.S. Patent Application No. 62/011,342, filed on Jun. 12, 2014, the entire content of which is herein incorporated by reference.

### FIELD OF THE INVENTION

The present invention is generally directed to data analysis, and more particularly to analysis of transaction information to identify a subset of relevant transactions and an associated product.

### BACKGROUND

An institution that offers a variety of products or services may want to identify current customers who are likely to purchase or use additional products offered by the institution. A current customer may be identified as likely to purchase or use an additional product if the current customer has purchased or used a similar product offered by a competitor institution and would be financially better off to obtain the product from the current institution.

In the case of a financial institution, such as a community bank or a credit union, the institution may want to identify an existing customer that has a checking account with the institution and a loan with a competitor institution as a potential customer for a loan. If the institution can identify such a customer and offer the customer a loan with more competitive terms, then the customer may decide to obtain a loan from the institution. Even if the customer does not obtain a loan from the institution, the customer may have a favorable impression of the institution's interest and ability in providing a relevant product.

Since the information needed to identify such a customer may not be available solely from the transaction information for the customer's account, a system that is able to use both structured information, such as transaction records, and unstructured information, such as text-based information from a check or other document, may be beneficial. In addition, it may be beneficial to consider all of the relationships that the customer may have with a product, such as owner, borrower, guarantor, or signatory. It is also beneficial to have a certain level of confidence that a product has been correctly identified and that the customer is likely to be receptive to an offer for a similar product.

### SUMMARY OF THE INVENTION

The present invention is directed to systems and methods for filtering and analyzing structured data (e.g. transaction records) and unstructured data (e.g. text from documents) for a customer of an institution in order to identify relevant transactions and the products associated with them. Once a customer-product pair is identified, the system further calculates additional qualification factors to select customers with the highest likelihood of obtaining a target product from the institution.

In one aspect of the invention the institution is a financial institution and the data includes transaction records for all accounts and products associated with a customer at the financial institution. The analysis performed by the system is distinguishable from an analysis of credit card transactions in several key ways. For example, the present analysis uses unstructured data, does not rely upon a merchant ID number, and does not require data related to credit card transactions.

Two types of analysis used are: sequential analysis and comparative analysis. Sequential analysis is used to filter and analyze the data to identify subsets with a common characteristic based on text analysis, such as subsets having one or more common terms, keywords, or key phrases. Comparative analysis is used to filter and analyze the data to identify subsets with a common characteristic based on a pattern in the amount or recurrence. The two types of analysis can be used independently or co-leveraged to identify a customer-product pair, which may then be further qualified.

These and other aspects of the invention will be described in more detail below and in the accompanying figures.

### BRIEF DESCRIPTION OF THE DRAWINGS

FIG. 1 is a block diagram illustrating the operation of an exemplary system.

FIG. 2 is a flowchart illustrating an exemplary sequential analysis.

FIG. 3 is a flowchart illustrating an exemplary comparative analysis.

FIG. 4 is a screenshot of an exemplary user interface illustrating customer results.

FIG. 5 is a screenshot of an exemplary user interface illustrating institution-wide results.

### DETAILED DESCRIPTION

Two types of data are used to identify customers with an existing product. In one implementation, the system uses existing data from a financial institution's computer system that includes both structured and unstructured data. Structured data includes transaction records and unstructured data includes documents or other sources of text-based information. In a first stage, sequential and comparative analysis are used. Sequential analysis is used to filter and analyze the data to identify subsets of transactions with a common characteristic based on text analysis. Comparative analysis is used to filter and analyze the data to identify subsets of transactions with a common characteristic based on a pattern. The system may further qualify an identified customer-product pair to identify customers with the highest likelihood of moving a product to the institution or of obtaining a similar product from the institution.

### Exemplary System

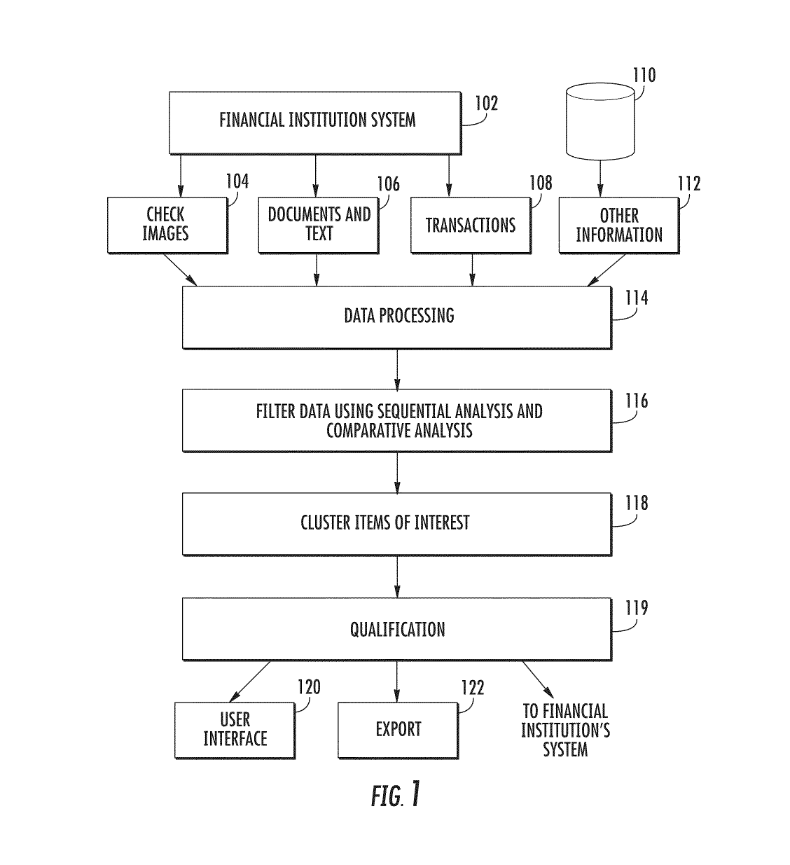

FIG. 1 is an overview of an exemplary system and its operation. The system may be part of the institution's system or may be a separate system. Information is received from a financial institution's system 102 and possibly another external source 110. The other information 112 from the external source may include credit reports or information available from public records. Customer names or customer addresses that appear in the other information 112 may be used to relate the other information to the information from the financial institution.

The financial institution's system 102 may provide check images 104, documents and text 106, and transaction records 108. Check images 104 and documents and text 106 are examples of unstructured data, also referred to herein as text-based data. A check image might be received as a .jpeg or similar file and converted to a .pdf or similar file with optical character recognition (OCR) enabled to extract information from the check image. Transaction records 108 are examples of structured data, and might be provided through a database interface. Other information 112 may be either structured or unstructured data.

The received information is processed in step 114. Step 114 includes Extract Transform Load (ETL) processing, where the data is extracted from the records provided by the financial institution or other sources, transformed to the appropriate format, and loaded into the system in an optimized structure.

The system may scrub any information that may be used to identify a specific person or entity or a specific account, and instead may use alternative identifiers to maintain confidentiality. The use of alternative identifiers allows the system to identify relationships between transactions, such as transactions for the same customer, without using personal information. Data processing 114 may also include identifying any products the customer already has with the financial institution.

After the data processing step 114, the data is filtered at 116. The data may be filtered using sequential analysis and comparative analysis. These two types of analyses identify data points by analyzing both structured and unstructured data. The system may determine the customer associated with the transaction, the product being delivered by a competitor institution, and the amount the customer is paying currently. In some instances the system may use text-based information, such as information on the memo field of a check or the endorser of the check, since such information is typically not available from the transaction information. Once the system knows three data points: 1) customer, 2) product, and 3) amount, the system analyzes the data to match transactions based on this information and the associated payment patterns for a given product. For instance, if the product is a mortgage, the system looks for monthly transactions of amounts that are similar to the expected amount. In some instances, the system may have sufficient transactional history to determine the origination date. The system clusters data points of interest at 118. For example, transactions with the same payee may be clustered together.

Once data points of interest are identified, the system may use various qualification criteria to determine whether a customer is likely to consolidate their financial accounts or products with the institution at 119. Examples of qualification criteria include borrowings with the customer relative to statutory maximum lending capacity, currently applicable interest rates, the rate differential between the current rate of an existing product and the market rate, the customer's credit score, product type, account type, time since origination of the product, the dollar amount of the opportunity, the transactional frequency of the item of interest, income and expense ratios for the customer, and general interest in the institution to lend to that particular customer based on insider status or other criteria based on business judgement. In one implementation, the credit score is available from the institution, but in other implementations it may be available as other information 112. Ultimately, the system identifies a set of customers, each with an identified product at a competitor institution that has been qualified so that it is likely that the customer will obtain or move the product from the financial institution.

The results of the processing may be sent to the system's user interface 120 and displayed to a user, exported into a spreadsheet or similar file 122, or imported to the financial institution's system 102.

### Sequential Analysis

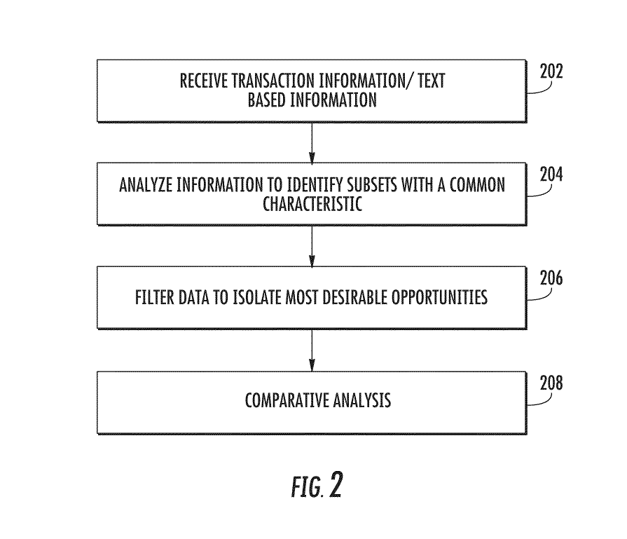

FIG. 2 is a flowchart of an exemplary sequential analysis or text based process. At 202, the system receives the transaction information and/or text-based information. At 204, the system analyzes the information to identify subsets of transactions with a common characteristic. For every piece of unstructured information, the system attempts to identify the associated account; the date of the information; the type of information, such as whether it is transaction related, credit report related, a loan document, a personal financial statement, or account opening information.

Once the system has associated a data point to a specific account, the system attempts to extract leverageable information regarding the account. For example, if the data point (i.e., piece of information) is a check image, the system may be able to extract text from the memo line, which may indicate that the check is for a mortgage payment or a loan, even though the payee name may indicate another type of payment. The system may use information on the front or the back of the check image and/or may determine the type of account used to make the payment in order to help identify a product, such as a commercial mortgage transaction. The system can determine if a similar transaction amount has occurred in other months from the same account or other accounts that the customer owns. If so, it can begin clustering the similar transactions as a commercial mortgage payment stream. These steps are described in more detail in the comparative analysis section below.

The system evaluates data associated with each customer. The data may include a check number, transaction code value, transaction code description value, application number, application, debit/credit indicator, transaction amount, effective date, transaction block value, transaction block number, transaction code modifier, and a description of the transaction, as well as other data that might be associated with that transaction. These fields are evaluated to determine details about the transaction. For example, the transaction code value or the transaction code description value may be used to determine the type of transaction, such as ACH, EFT, “insider” transaction, etc. An insider transaction is a transaction involving an employment relationship, which exists when the transaction involves an employee of the financial institution, a member of the Board of Directors, or some other relationship with the institution beyond a simple customer. A variety of encoded fields, such as a transaction code, may be used to identify transactions that have a high likelihood of indicating an external financial product. The application number or application may be used to identify a product, customer, or account or any combination of these.

The system attempts to categorize each transaction into a distinct industry (e.g. banking), a distinct company (e.g. U.S. Bank), and a distinct activity (e.g. loan payment). A single transaction may actually be categorized by the system into multiple industries, companies, or activities. The system has a method of ratings, or weights, which it applies in real time to specify the strength of each classification. The system then selects the strongest classification for each particular transaction. Thus, the quality rating indicates the likelihood that the identified industry, company, and activity are all correct. In some instances, once the system determines a company and an activity, it derives the industry.

The system determines the industry associated with the transaction by mining every available field to determine the total list of matches with a known taxonomy of terms. The terms represent likely terms for a variety of industries. More than one term may be associated with the same industry. The terms may be updated as the system identifies additional terms used for an industry. Once the industry is determined, then the system assigns an industry rating to the transaction.

The system determines the company associated with the transaction by mining every available field to determine the total list of matches with a known taxonomy of terms. The terms represent likely terms used for company names. More than one term may be associated with the same company name. For example, the terms “U.S. Bank” and “United States Bank” may both be associated with the company name “U.S. Bank”. The terms may be updated as the system identifies additional terms used for a company name. Once the company name is determined, then the system assigns a company rating to the transaction.

The system also identifies an activity likely to be associated with the transaction. Exemplary activities include, but are not limited to, mortgage payments, loan payments, merchant fees, deposits, and brokerage account activity. Once an activity is identified, then the system assigns an activity rating to the transaction. Some activities are more general than others. For example, a transaction with the local car dealership might indicate the potential for a car loan. However, if that transaction was only for $150, it is probably a simple repair or small retail purchase. However, an $800 transaction with a vehicle finance company might indicate the presence of a car loan. If similar transactions are identified that occur each month, then the probability that this transaction is for a car loan increases. Furthermore, that transaction occurring within the same ten day period of the month for multiple months in a row would provide even further validation that the transaction is for a car loan.

After analyzing the data, the process continues to 206, where it filters the data to isolate the most desirable opportunities. The filtering process may be based on what types of products the financial institution offers, current interest rates, or other relevant information. For example, the system may track the “newness” of activity associated with each product such that an officer of the financial institution is able to determine what is “new” for the customers for whom the officer is responsible. A customer who has recently conducted a certain type of transaction with another institution may be interested in other related transactions. Data can be pulled monthly, weekly, daily, on demand, or at any other appropriate period. The measure of “newness” can be configurable.

One embodiment of the filtering process is the Deal of the Day, which is the biggest, most highly qualified opportunity being tracked within the customer base of the financial institution. There are options to get the overall Deal of the Day as well as to get the Deal of the Day for specific types of accounts only, such as commercial accounts. The data is analyzed to determine which customers are most likely to be interested in the Deal of the Day.

After the data has been analyzed and filtered using sequential analysis, it may be further analyzed using comparative analysis in step 208.

### Comparative Analysis

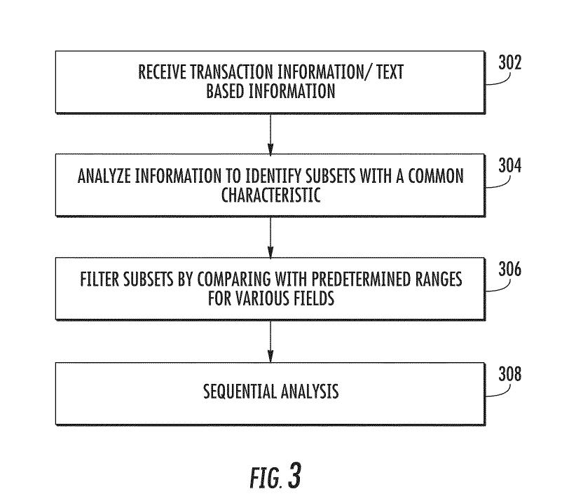

FIG. 3 is a flowchart of the comparative analysis or pattern analysis process.

Comparative analysis begins by receiving transaction information and text based information at 302. Then the comparative analysis proceeds to analyze the information to identify subsets having a common characteristic at 304. Comparative analysis uses the amount, frequency, periodicity, transaction encodings, or transaction type of the transactions to identify patterns. For example, the system attempts to classify every transaction according to day of the week; month of the year; year; ten (10) day period, or other portion of the month; whether the transaction was a debit or a credit; and a transaction type, for example, whether the transaction was conducted by wire, an automatic clearing house (ACH) transfer, check, or debit card. In one implementation, the system evaluates characteristics of the transactions, such as the amount of the transaction and the date of the transaction to identify subsets of transactions having a common characteristic.

In step 306, the system compares the characteristics to a set of predefined values in order to eliminate transactions that are probably not relevant or to identify transactions that may be related.

In one implementation, the system compares the amount of the transaction to an amount range and compares the recurrence of the transaction to a recurrence range. The recurrence range is further reduced to exclude payments where the frequency of occurrence is too great for a financial product. For instance, the system may filter out the following pattern as not likely to indicate a financial product: $5,612.19 payment that occurs 12 times in the same month with distinct checks. There are instances where multiple payments in a given month for the same product are allowed. However, if that duplication of payments exceeds a predefined threshold, then they are eliminated from further analysis. The predefined values for the amount range and the recurrence range are selected based on the likely characteristics of a relevant transaction. In addition, it is possible that the system may use ranges for other types of fields. Since there may be some variation in the amount of a recurring transaction, the system allows a configurable, predefined amount of variation between transactions. For example, a variation of 1% of the amount may be allowed between transactions. If so, then the system may identify a recurring payment if it identifies a payment of $3000 and a payment of $3030 thirty days later. Or the variation in the amount might be set to reflect an appropriate interest rate fluctuation or late fee. If the system is configured to identify customers with loans from other institutions, then the predefined values may be selected to reflect the type of loans that the client institution wants to target. For instance, a client may select a payment range intended to exclude auto loans, if the institution does not provide auto loans. Setting a minimum amount may also eliminate large quantities of recurring transactions that are more likely to reflect a regular beverage purchase, for example, than a loan.

### Co-Leveraging Comparative and Sequential Analysis

As an example of how the system co-leverages Sequential Analysis and Comparative Analysis, the system may detect payments from a customer to Bank A, or another selected party, using sequential analysis. If the payments are not all of the same amount, then it may be difficult to identify a product associated with the payments using only sequential analysis. This is how comparative analysis can be used to inform sequential analysis. Under comparative analysis, the payments may be identified as having a common characteristic in step 304 if the payments are all within a certain range. In 306, the system will check to see if the payment amounts fall with a predefined amount range and a predetermined recurrence range. If the payments are within the amount range and recurrence range for a mortgage, the system may leverage that information along with the knowledge that the payment is going to Bank A and payments are made out of a commercial account to determine that the customer has a commercial mortgage with Bank A based on both sequential and comparative analysis.

After a group of payments has been identified as recurring and of similar amounts using comparative analysis, these transactions can be run through the sequential analysis 308, to evaluate the various fields associated with the transaction in an effort to improve the likelihood of correctly identifying the type of payments being made. In this way, the sequential analysis and the comparative analysis are used together.

Co-leveraging the two types of analysis, or running the results of one through the other, increases the certainty and breadth of the results.

### Qualification

Once a product and a customer are identified as a customer-product pair, such as a customer with a certain identifier and a mortgage, the system may further qualify the customer or the combination of the customer and the product. The system may calculate the qualification status of each customer-product pair based on one or more of the following: insider vs. outsider status; dollar value of the opportunity; age of product already purchased; reference rate at origination, rate gap (i.e. today's rate compared to the rate at origination); credit score; classified and watch list credits; ability for bank to sell the product to customer based on capital constraints; strategic focus of the bank in terms of driving growth; average daily balance; income to expense ratios; income to balance ratios; and the target financial institution. The institution is able to weigh these criteria differently based on the particular characteristics of their customer base and their needs at any given point in time.

The system uses the results from both the sequential analysis and the comparative analysis as well as lead qualification to generate a list of existing customers that are likely to be interested in consolidating their banking. As the output is used, additional information may be obtained and may be used to update the system or the terms, ranges, ratings, or predefined values used by the system. For example, if a customer is identified as being a likely candidate for a loan based on a recurring transaction, but it is subsequently determined that the transactions identified as likely loan payments were actually insurance payments, then the terms and ratings used for text mining or the ranges used for comparative mining may be updated.

In some embodiments, the system may have access to additional qualification criteria that indicate a relatively higher or lower probability that a customer belongs to a group that has a high propensity of having a financial product even though the system has not been able to cluster data points that would prove the existence of that product. This is referred to as Customer Proximity Mining.

Customer Proximity Mining is the process by which the system groups customers together based on financial characteristics like deposit frequency and amount; existing products currently utilized; total income; total expenditures; credit information; demographic information; socioeconomic information; or other information. Once the system has formed a group, it can draw conclusions on the entire group based on distinct external knowledge of a subset of the group. For instance, people in the same socioeconomic strata tend to have very similar financial needs, and thus very similar product sets. If the system groups customers based on socioeconomic criteria and has determined that this group is highly to have a home equity line of credit (HELOC), then the system may declare that everyone in the group has a high likelihood of owning a HELOC based on those criteria.

### Exemplary System Output

The output can be provided in a variety of ways, including the generation of a spread sheet or the generation of a file that can be accessed via a user interface displayed on a screen. The output may also be imported into another system belonging to the financial institution and then displayed to the user. In this manner, the output may prompt employees of the institution to offer a customer information about a product when the employee is interacting with the customer. If the output is imported into the financial institution's system, then customer information, such as name and account number, may be displayed.

The system's graphical user interface (GUI) allows the user to sort and filter the data to isolate the opportunities which are most desirable. The GUI allows the user to drill into the data in the following ways: product type (loans, deposits, merchant services, credit cards, etc.); customer; customer type (business or consumer); and product size (for example, $100 k or $1 million+). The data presented may be related to a customer or may be related to all customers of the financial institution.

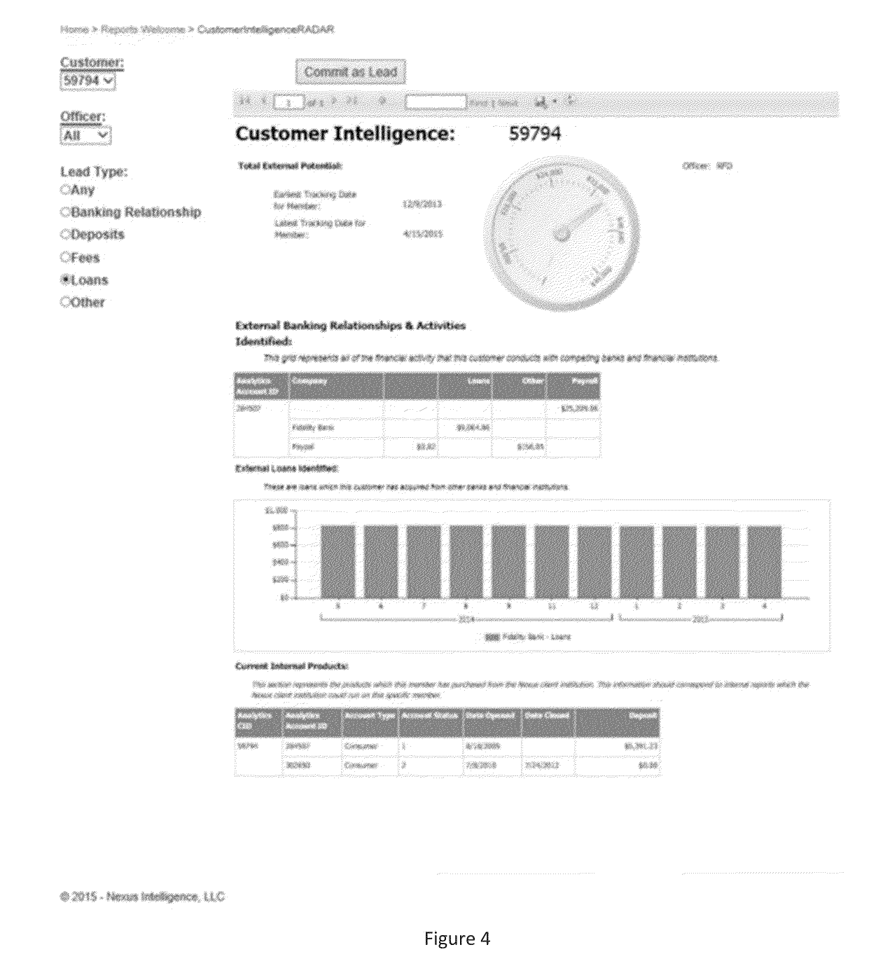

FIG. 4 shows a screenshot of a Customer Intelligence Report, which is a summary of loans that the system is tracking on a customer identified by identifier 59794. The screenshot includes a section that summarizes the external banking relationships and activities for the customer and a section that summarizes the customer's accounts at the financial institution.

The system may also provide a Target Marketing Report. This report represents all opportunities which the system is currently tracking for a customer. In some instances, the system may have the name of a company to which the customer is sending money, but may not know why the customer is sending money to another financial institution. However, a single payment may develop into a pattern of payments over time, which allows the system to declare the financial product to be a loan or deposit account at the competing institution based on identified characteristics of the payment stream.

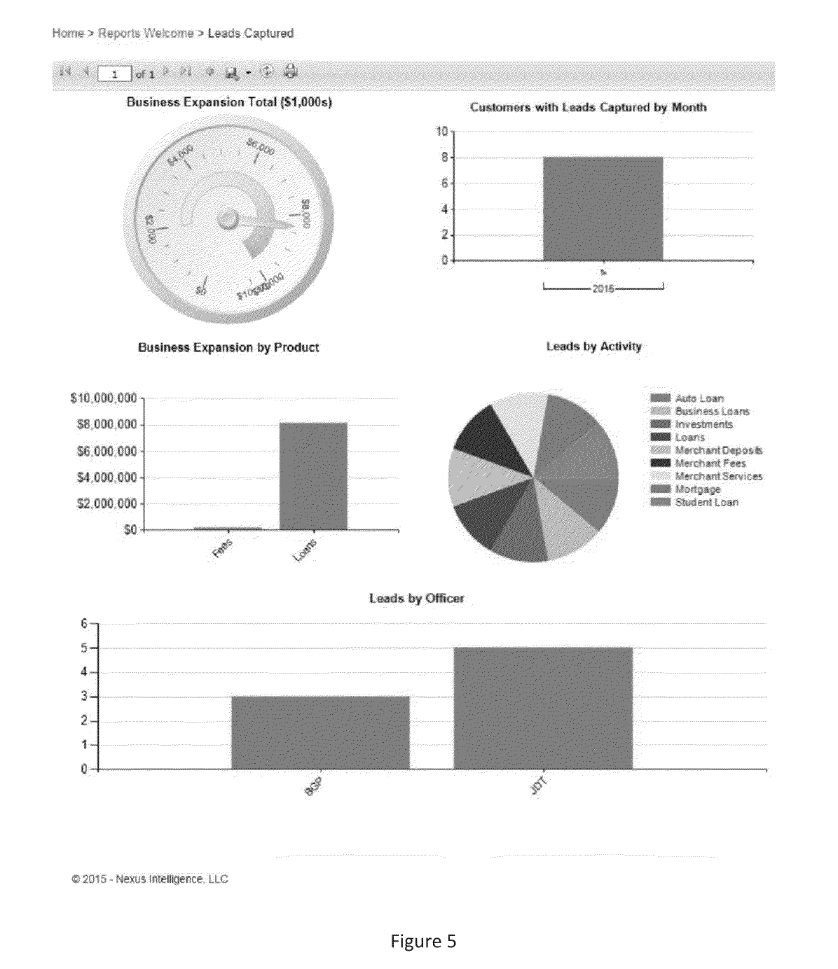

Business expansion tracking is also included. FIG. 5 shows a screenshot of one implementation of a Leads Captured Report. The Leads Captured Report shows the breakdown of opportunities which the system is tracking according to bank officer, product type (e.g. Activity), resulting business expansion, etc.

The system also allows the financial institution to “commit” a customer for tracking, causing the system to automatically track business expansion for that customer. Both positive business expansion and business shrinkage are tracked and then summed by product and in total.

Aspects of the present invention may be implemented using any combination of computer hardware and software and may use one or more computer systems connected in any manner, including across a network. Any software may be stored as computer-executable instructions on a computer-readable medium. Any computer system may include one or more processing devices for rendering a user interface, as well as one or more memory devices for storing information. There may be communications with third party systems to obtain or verify data. Communications within the system or between systems may use any combination of wired and/or wireless communication methods and any suitable communication protocols. The system may include an input device configured to receive information collected in the normal course of financial institution operations. The system may include an output device configured to present the results of the system processing to a user.

The foregoing is provided for purposes of illustrating, describing, and explaining aspects of the present invention and is not intended to be exhaustive or to limit the invention to the precise forms disclosed. Further modifications and adaptation of these embodiments will be apparent to those skilled in the art and may be made without departing from the scope and spirit of the invention. Different arrangements of the components described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent.

What is claimed is:

1. A system for filtering and analyzing information to identify a target product, comprising:
an input device;
an output device;
a memory; and
a processor for executing instructions stored on a computer-readable medium on one or more devices providing steps comprising:
receiving transaction information that includes information related to amounts, dates, and parties for a first plurality of transactions, wherein the transaction information is extracted from a plurality of transaction records associated with a first customer;
receiving text-based information that includes information related to amounts, dates, and parties for a second plurality of transactions, wherein the first plurality of transactions and the second plurality of transactions overlap, and the text-based information is extracted from a plurality of documents associated with the first customer;
analyzing the transaction information to identify subsets of the first plurality of transactions, wherein each subset has at least one common characteristic;
filtering the transaction information to identify a first subset of the first plurality of transactions for further analysis based on the common characteristic of the first subset of the first plurality of transactions;
analyzing the transaction information that remains after the filtering to identify a second subset of transactions, wherein each transaction in the second subset of transactions is associated with a selected party;
analyzing the text-based information to identify subsets of the second plurality of transactions, wherein each subset has at least one common characteristic;
filtering the text-based information to identify a first subset of the second plurality of transactions for further analysis based on the common characteristic of the first subset of the second plurality of transactions;
analyzing the text-based information that remains after the filtering to identify a third subset of transactions, wherein each transaction in the third subset of transactions is associated with a selected amount range or a selected recurrence range;
comparing the second subset of transactions and the third subset of transactions to identify a fourth subset of transactions, wherein each of the transactions in the fourth subset of transactions is associated with the selected party and the selected amount range or the selected recurrence range;
eliminating transactions in the fourth subset of transactions that do not meet a set of qualification criteria; and
using the remaining transactions in the fourth subset of transactions to identify a target product associated with the selected party and the first customer.

2. The system of claim 1, wherein the plurality of documents associated with the first customer include at least one of: check images for at least one account associated with the first customer, a financial statement associated with the first customer; account information for at least one account associated with the first customer, and a loan document associated with the first customer.

3. The system of claim 2, wherein the text-based information includes text on check images.

4. The system of claim 1, wherein the transaction information includes transactions from a plurality of accounts associated with the first customer.

5. The system of claim 1, wherein filtering the transaction information to eliminate a subset of the first plurality of transactions from further analysis further comprises filtering based on an amount.

6. The system of claim 1, further comprising applying qualification criteria to the target product and the first customer, wherein the qualification criteria for the target product includes an age of the product and the qualification criteria for the first customer is selected from the list comprising: a status of the customer based on desirability of selling that customer additional financial products, employment relationship, or products which this customer has already purchased from the institution.

7. The system of claim 1, wherein the selected amount range corresponds to a payment associated with the target product.

8. The system of claim 1, wherein filtering the transaction information to identify a first subset of the first plurality of transactions for further analysis based on the common characteristic of the first subset of the first plurality of transactions comprises sequential analysis.

9. The system of claim 1, wherein filtering the text-based information to identify a first subset of the second plurality of transactions for further analysis based on the common characteristic of the first subset of the second plurality of transactions comprises comparative analysis.

10. The system of claim 1, wherein analyzing the transaction information and analyzing the text based information further comprises grouping customers together into a group based on financial characteristics, demographic characteristics, or socioeconomic characteristics and identifying target products for an entire group based on distinct external knowledge of a subset of the group.

11. A system for filtering and analyzing information to identify a target product, comprising:
an input device;
an output device;
a memory; and
a processor for executing instructions stored on a computer-readable medium on one or more devices providing steps comprising:
receiving transaction information that includes information related to amounts, dates, and parties for a first plurality of transactions, wherein the transaction information is extracted from a plurality of transaction records associated with a first customer;
receiving text-based information that includes information related to amounts, dates, and parties for a second plurality of transactions, wherein the first plurality of transactions and the second plurality of transactions overlap, and the text-based information is extracted from a plurality of documents associated with the first customer;
analyzing the transaction information to identify subsets of the first plurality of transactions, wherein each subset has at least one common characteristic;
filtering the transaction information to identify a first subset of the first plurality of transactions for further analysis based on the common characteristic of the first subset of the first plurality of transactions;
analyzing the transaction information that remains after the filtering to identify a second subset of transactions, wherein each transaction in the second subset of transactions is associated with a selected party;
analyzing the text-based information to identify subsets of the second plurality of transactions, wherein each subset has at least one common characteristic;
filtering the text-based information to identify a first subset of the second plurality of transactions for further analysis based on the common characteristic of the first subset of the second plurality of transactions;
analyzing the text-based information that remains after the filtering to identify a third subset of transactions, wherein each transaction in the third subset of transactions is associated with the selected party;
comparing the second subset of transactions and the third subset of transactions to identify a fourth subset of transactions, wherein each of the transactions in the fourth subset of transactions is associated with the selected party;
eliminating transactions in the fourth subset of transactions that do not meet a set of qualification criteria; and
using the remaining transactions in the fourth subset of transactions to identify a target product associated with the selected party and the first customer.

12. The method of claim 11, wherein the plurality of documents associated with the first customer include at least one of: check images for at least one account associated with the first customer, a financial statement associated with the first customer; account information for at least one account associated with the first customer, and a loan document associated with the first customer.

13. The method of claim 12 wherein the text-based information includes text on check images.

14. The method of claim 11, wherein the transaction information includes transactions from a plurality of accounts associated with the first customer.

15. The method of claim 11, wherein filtering the transaction information to eliminate a subset of the first plurality of transactions from further analysis further comprises filtering based on an amount.

16. The method of claim 11, further comprising applying qualification criteria to the target product and the first customer, wherein the qualification criteria for the target product includes an age of the product and the qualification criteria for the first customer is selected from the list comprising: a status of the customer based on desirability of selling that customer additional financial products, an employment relationship, or products which this customer has already purchased from the institution.

17. The method of claim 11, wherein the selected amount range corresponds to a payment associated with the target product.

18. The method of claim 11, further comprising:
analyzing the transaction information that remains after the filtering to identify a fifth subset of transactions, wherein each transaction in the fifth subset of transactions is associated with a selected amount range or a selected recurrence range;
analyzing the text-based information that remains after the filtering to identify a sixth subset of transactions, wherein each transaction in the sixth subset of transactions is associated with a selected amount range or a selected recurrence range; and
wherein comparing the second subset of transactions and the third subset of transactions further comprises comparing the fifth subset of transactions and the sixth subset of transactions, and wherein each of the transactions in the fourth subset of transactions is associated with the selected party and the selected amount range or the selected recurrence range.

19. A system for filtering and analyzing information to identify a target product, comprising:
an input device;
an output device;
a memory; and
a processor for executing instructions stored on a computer-readable medium on one or more devices providing steps comprising:
receiving transaction information that includes information related to amounts, dates, and parties for a first plurality of transactions, wherein the transaction information is extracted from a plurality of transaction records associated with a first customer;
receiving text-based information that includes information related to amounts, dates, and parties for a second plurality of transactions, wherein the first plurality of transactions and the second plurality of transactions overlap, and the text-based information is extracted from a plurality of documents associated with the first customer;
analyzing the transaction information to identify subsets of the first plurality of transactions, wherein each subset has at least one common characteristic;
filtering the transaction information to identify a first subset of the first plurality of transactions for further analysis based on the common characteristic of the first subset of the first plurality of transactions;
analyzing the transaction information that remains after the filtering to identify a second subset of transactions, wherein each transaction in the second subset of transactions is associated with a selected amount range or a selected recurrence range;
analyzing the text-based information to identify subsets of the second plurality of transactions, wherein each subset has at least one common characteristic;
filtering the text-based information to identify a first subset of the second plurality of transactions for further analysis based on the common characteristic of the first subset of the second plurality of transactions;
analyzing the text-based information that remains after the filtering to identify a third subset of transactions, wherein each transaction in the third subset of transactions is associated with the selected amount range or the selected recurrence range;
comparing the second subset of transactions and the third subset of transactions to identify a fourth subset of transactions, wherein each of the transactions in the fourth subset of transactions is associated with the selected amount range or the selected recurrence range;
eliminating transactions in the fourth subset of transactions that do not meet a set of qualification criteria; and
using the remaining transactions in the fourth subset of transactions to identify a target product associated with the first customer and the selected amount range or the selected recurrence range.

20. The method of claim 19, further comprising:
analyzing the transaction information that remains after the filtering to identify a fifth subset of transactions, wherein each transaction in the fifth subset of transactions is associated with a selected party;
analyzing the text-based information that remains after the filtering to identify a sixth subset of transactions, wherein each transaction in the sixth subset of transactions is associated with the selected party; and
wherein comparing the second subset of transactions and the third subset of transactions further comprises comparing the fifth subset of transactions and the sixth subset of transactions, and wherein each of the transactions in the fourth subset of transactions is associated with the selected party and the selected amount range or the selected recurrence range.
